(19) United States
(12) Patent Application Publication
(10) Pub. No.: US 2021/0286280 A1
(43) Pub. Date: Sep. 16, 2021

(54) TONER AND TONER MANUFACTURING METHOD

(71) Applicant: KYOCERA Document Solutions Inc., Osaka-shi (JP)

(72) Inventor: Haruhiro Hatajiri, Osaka-shi (JP)

(21) Appl. No.: 17/196,058

(22) Filed: Mar. 9, 2021

(30) Foreign Application Priority Data
Mar. 16, 2020 (JP) 2020-045211

(51) Int. Cl. G03G 9/087; G03G 9/08

(52) U.S. Cl. CPC G03G 9/08755; G03G 9/081; G03G 9/0821; G03G 9/0827

(57) ABSTRACT

A toner contains toner particles. The toner particles have an average circularity of 0.900 to 0.950. The toner particles have an arithmetic average surface roughness value of 30 to 100 nm. A ratio of a surface roughness standard deviation of the toner particles to the arithmetic average value is 0.3 or lower. The arithmetic average value of surface roughness of the toner particles is preferably 30 to 50 nm.

### INCORPORATION BY REFERENCE

This application is based upon, and claims the benefit of priority from, corresponding Japanese Patent Application No. 2020-045211 filed in the Japan Patent Office on Mar. 16, 2020, the entire contents of which are incorporated herein by reference.

### BACKGROUND

### Field of the Invention

The present disclosure relates to a toner, and a toner manufacturing method.

### Description of Related Art

In an electrophotographic method, an electrostatic latent image on an image carrier is developed as a toner image using a toner. The toner image is transferred to a recording medium from the image carrier. It is known that a toner excellent in transferability can be obtained by increasing a circularity of the toner.

### SUMMARY

The toner according to the present disclosure includes toner particles. An average circularity of the toner particles is 0.900 to 0.950. An arithmetic average value of a surface roughness of the toner particles is 30 to 100 nm. A ratio of a standard deviation of the surface roughness of the toner particles to the arithmetic average value is 0.3 or lower.

The toner manufacturing method according to the present disclosure refers to a method for manufacturing a toner containing toner particles. The toner manufacturing method according to the present disclosure includes a temperature raising process in which, while stirring a core in a liquid containing a thickener and an aqueous medium, the liquid is raised from a first temperature to a second temperature to obtain toner particles. A viscosity of the thickener is 400 to 10000 mPa·sec. A content of the thickener is 1.0 to 10.0 parts by mass based on 1000.0 parts by mass of the aqueous medium. The second temperature is 50° C. to 60° C. An average circularity of the toner particles is 0.900 to 0.950. An arithmetic average value of a surface roughness of the toner particles is 30 to 100 nm. A ratio of a standard deviation of the surface roughness of the toner particles to the arithmetic average value is 0.3 or lower.

### BRIEF DESCRIPTION OF THE DRAWINGS

FIG. 1 is a sectional view illustrating an example of a toner particle contained in a toner according to the first embodiment of the present disclosure; and

FIG. 2 is an enlarged sectional view illustrating a surface portion of the toner particle contained in the toner according to the first embodiment of the present disclosure.

### DETAILED DESCRIPTION

First, meanings of terms used in the present specification and a measurement method will be explained. Unless otherwise specified, an evaluation result (a value indicating a shape, a physical property, etc.) of a powder (more specifically, toner particle, core, external additive, toner, etc.) is represented by an arithmetic average of values measured for a considerable number of particles contained in the powder.

Unless otherwise specified, a glass transition point (Tg) and a melting point (Mp) are values measured in accordance with JIS (Japanese Industrial Standards) K7121-2012 using a differential scanning calorimeter (“DSC-6220” manufactured by Seiko Instruments Inc.). In an endothermic curve (ordinate axis: heat flow (DSC signal), abscissa axis: temperature) of a sample measured by the differential scanning calorimeter, a temperature at a flexion point resulting from glass transition is the glass transition point (Tg). Specifically, the temperature at the flection point resulting from glass transition is a temperature at an intersection of an extrapolation line of a baseline and an extrapolation line of a falling line. A temperature at the maximum endothermic peak in the endothermic curve is the melting point (Mp). Hereinafter, the “glass transition point” is abbreviated as “Tg” and the “melting point” is abbreviated as “Mp” in some cases.

Unless otherwise specified, a melting temperature (Tm) is a value measured using a Koka-type flow tester (“CFT-500D” manufactured by Shimadzu Corporation). In an S-curve (abscissa axis: temperature, ordinate axis: stroke) of the sample measured by the Koka-type flow tester, a temperature at “(baseline stroke value+maximum stroke value)/2” is the melting temperature (Tm). Hereinafter, the “melting temperature” is abbreviated as “Tm” in some cases.

Unless otherwise specified, an acid value is a value measured in accordance with JIS (Japanese Industrial Standards) 1(0070-1992.

Unless otherwise specified, a volume median diameter (D₅₀) of the powder is a value measured based on the Coulter principle (aperture electrical resistance method) using “Coulter Counter Multisizer 3” manufactured by Beckman Coulter, Inc. Hereinafter, the “volume median diameter” is abbreviated as “D₅₀” in some cases.

Unless otherwise specified, each number average primary particle diameter refers to an arithmetic average value of an equivalent circle diameter (Haywood diameter: diameter of a circle having an area equal to a projected area of the particle) of a primary particle measured using a microscope.

Unless otherwise specified, as for respective materials to be explained in the embodiments of the present disclosure, only one material may be used, or two or more materials may be used in combination. In addition, a term “independently” used for explanation of general formulas means “may be the same or different”. In addition, a compound and its derivatives are comprehensively called by adding “-based” after the compound name in some cases. In addition, a case that a polymer name is called by adding “-based” after the compound name means that a repeating unit of the polymer is derived from the compound or its derivatives. In addition, acryl and methacryl are comprehensively referred to as “(meth)acryl” in some cases. Acrylonitrile and methacrylonitrile are collectively referred to as “(meth)acrylonitrile” in some cases. As described above, meanings of terms used in the present specification, and the measurement method have been explained. Next, the embodiments of the present disclosure will be explained.

### FIRST EMBODIMENT: TONER

Hereinafter, a toner according to the first embodiment of the present disclosure will be explained. The toner according to the first embodiment contains toner particles. The toner is an aggregate (powder) of the toner particles.

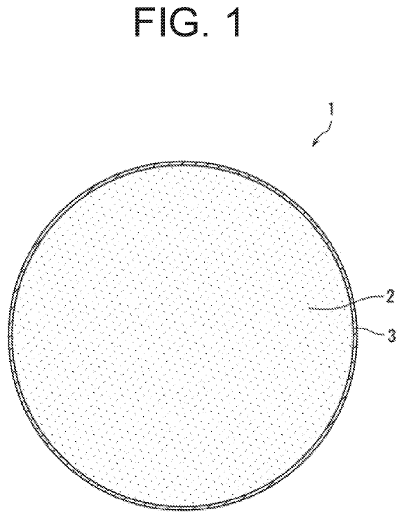

Hereinafter, a structure of a toner particle 1 will be explained with reference to FIG. 1. FIG. 1 is a sectional view illustrating an example of the toner particle 1. The toner particle 1 has a core 2 and a shell layer 3. The shell layer 3 covers a surface of the core 2. The shell layer 3 may cover the whole or a part of the surface of the core 2. The toner particle 1 is an encapsulated toner particle including the shell layer 3.

Incidentally, the toner particle 1 may be an unencapsulated toner particle including no shell layer 3. When the toner particle 1 is an unencapsulated toner particle, the shell layer 3 in FIG. 1 is omitted, and the core 2 is equivalent to the toner particle 1.

Note that, for ease of explanation, the toner particle 1 including no external additive was explained. However, the toner particle 1 contained in the toner according to the first embodiment may further include an external additive particle (not illustrated). For example, the toner particle may be a toner particle that uses the toner particle 1 illustrated in FIG. 1 as a toner mother particle and includes this toner mother particle and an external additive particle provided on a surface of the toner mother particle. As described above, the structure of the toner particle has been explained with reference to FIG. 1.

The toner particles contained in the toner according to the first embodiment have an average circularity of 0.900 to 0.950. The toner particles have an arithmetic average value of surface roughness of 30 to 100 nm. A ratio (σRa/Ra) of a surface roughness standard deviation (σRa) of the toner particles to the arithmetic average value of surface roughness (Ra) of the toner particles is 0.3 or lower. Hereinafter, the “arithmetic average value of surface roughness” is referred to as “average surface roughness” in some cases. In addition, the “ratio (σRa/Ra) of the surface roughness standard deviation (σRa) of the toner particles to the arithmetic average value of surface roughness (Ra) of the toner particles” is referred to as “ratio σRa/Ra” in some cases. In addition, the features that “the average circularity is 0.900 to 0.950, the average surface roughness is 30 to 100 nm, and the ratio σRa/Ra is 0.3 or lower” are referred to as “predetermined features” in some cases.

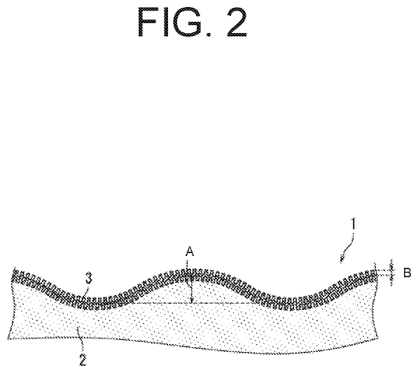

The predetermined features of the toner particle 1 will be explained with reference to FIG. 2. FIG. 2 is an enlarged sectional view illustrating a surface portion of the toner particle 1 contained in the toner. There are a plurality of first convex portions A and a plurality of second convex portions B on the surface of the toner particle 1. The first convex portions A are larger than the second convex portions B. The first convex portions A represent a waviness on the surface of the toner particle 1. The first convex portions A affect the circularity of the toner particle 1. On the other hand, the second convex portions B represent the surface roughness of the toner particle 1. The surface roughness of the toner particle 1 is represented by minute convex portions in a degree not affecting measurement of the circularity.

When the toner particle 1 has an average circularity of 0.900 to 0.950, large convex portions like the first convex portions A are moderately present on the surface of the toner particle 1, and the circularity is not too high. Thereby, the toner particle 1 becomes hard to pass through between an image carrier and a cleaning blade, and the toner is favorably cleaned by the cleaning blade. In addition, when the toner particle 1 has an average surface roughness of 30 to 100 nm and a ratio σRa/Ra of 0.3 or lower, minute convex portions like the second convex portions B are leveled. Thus, the toner particle 1 becomes easy to adhere to the recording medium, and the toner is favorably transferred to the recording medium. Thus, the toner according to the first embodiment can exhibit both good transferability and good cleanability.

The toner particle 1 having predetermined features can be obtained e.g. by a temperature raising process. In the temperature raising process while the core 2 is stirred in a liquid containing a thickener and an aqueous medium, the liquid is raised from the first temperature to the second temperature. The liquid containing the thickener has a high viscosity. The liquid having the high viscosity rubs the surface of the core 2, so that the minute convex portions are leveled. In addition, as the temperature of the liquid is raised, first, the minute convex portions are leveled, and as the temperature of the liquid is further raised, next, the large convex portions are leveled. After the minute convex portions are leveled, and before the large convex portions are leveled, the raising is terminated at the second temperature, so that the minute convex portions that affect the surface roughness can be leveled, and the large convex portions that affect the circularity can be left. As a result, the core 2 having predetermined features can be obtained. When the toner particle 1 is the unencapsulated toner particle, the core 2 having the predetermined features is equivalent to the toner particle 1 having the predetermined features. When the toner particle 1 is the encapsulated toner particle, the shell layer 3 is also formed in the temperature raising process. Thereby, in the temperature raising process, it is possible to simultaneously conduct all of a process of regulating the surface of the core 2 so as to have the predetermined features, a process of forming the shell layer 3 on the surface of the core 2, and a process of regulating the surface of the shell layer 3 so as to have the predetermined features, resulting in the toner particle 1 having the predetermined features. As described above, the predetermined features of the toner particle 1 have been explained with reference to FIG. 2. Incidentally, details of the toner manufacturing method will be described later in the second embodiment.

<Average Circularity>

The average circularity of the toner particles refers to an arithmetic average value of the circularity of the toner particles. As already described, the toner particles have an average circularity of 0.900 to 0.950. For improving the transferability and the cleanability with good balance, the average circularity of the toner particles is preferably 0.940 to 0.950. The average circularity of the toner particles is measured using e.g. a flow-type particle image analyzer (e.g. “FPIA (registered trademark)-3000” manufactured by Sysmex Corporation).

<Surface Roughness>

As already described, the toner particles have an average surface roughness of 30 to 100 nm. For improving the transferability of the toner, the average surface roughness of the toner particles is preferably 30 to 50 nm.

As already described, the ratio σRa/Ra is 0.3 or loser. The ratio σRa/Ra is an indicator of variability in the surface roughness among the toner particles. The lower the ratio σRa/Ra is, the smaller the variability in the surface roughness among the toner particles is. When the ratio σRa/Ra is 0.3 or lower, the variability in the surface roughness among the toner particles is small, and the toner particles having the surface roughness of higher than 100 nm are decreased. As a result, the toner particles become easy to adhere to the recording medium, and the toner is favorably transferred to the recording medium.

In the present specification, the surface roughness of the toner particles refers to a center line average roughness measured by a method described in or in accordance with JIS (Japanese Industrial Standards) B0601: 2013. The surface roughness of the toner particles is measured using a scanning probe microscope (e.g. SPM, “multifunctional unit AFM5200S” manufactured by Hitachi High-Tech Science Corporation). The surface roughness of a considerable number (e.g. 100) of toner particles is measured using the scanning probe microscope, and the arithmetic average value Ra and the standard deviation σRa of the toner particles are calculated from the measured surface roughness.

<Core>

The core included in the toner particle contains e.g. a binder resin, a releasing agent, and a colorant. Hereinafter, the binder resin, the releasing agent, and the colorant will be explained.

(Binder Resin)

The toner particles contain a binder resin. The binder resin accounts for most (e.g. 80% by mass or more) of the core. For obtaining a toner excellent in low-temperature fixability, a thermoplastic resin is preferable as the binder resin. Examples of the thermoplastic resin include a polyester resin, a styrene resin, an acrylic resin, an olefin resin (more specifically, polyethylene resin, polypropylene resin, etc.), a vinyl resin (more specifically, vinyl chloride resin, polyvinyl alcohol, vinyl ether resin, N-vinyl resin, etc.), a polyamide resin, and a urethane resin. In addition, a copolymer of each of these resins, i.e. a copolymer obtained by introducing any repeating unit into each of the aforementioned resins (more specifically, styrene acrylic resin, styrene-butadiene resin, etc.) can also be used as the binder resin.

For suitably obtaining the toner particles having the predetermined features, the styrene acrylic resin and the polyester resin are preferable as the binder resin. The styrene acrylic resin is a polymer of one or more types of styrene-based monomers and one or more types of acrylic acid-based monomers. The polyester resin is a polymer of one or more types of polyhydric alcohol monomers and one or more types of polycarboxylic acid monomers. Examples of the polyester resin include an amorphous polyester resin and a crystalline polyester resin.

The amorphous polyester resin refers to a polyester resin that does not show any clear endothermic peak in an endothermic curve measured using a differential scanning calorimeter. Since the amorphous polyester resin does not show any clear endothermic peak, the amorphous polyester resin does not have Mp.

The crystalline polyester resin refers to a polyester resin having a crystallinity index of 0.90 to 1.20. The crystallinity index of the polyester resin refers to a ratio (Tm/Mp) of a Tm (unit: ° C.) of the polyester resin to an Mp (unit: ° C.) of the polyester resin.

To obtain the toner particles having predetermined features, more preferably the binder resin contains a first amorphous polyester resin, a second amorphous polyester resin, and a third resin. The third resin contains a crystalline polyester resin and a styrene acrylic resin. In the temperature raising process, on the core containing such a binder resin, the minute convex portions are leveled by being rubbed with a liquid containing a thickener, and the minute convex portions are suitably leveled by raising the temperature of the liquid. Thus, a core having the predetermined features and thus a toner particle having the predetermined features can be suitably obtained.

Hereinafter, the first amorphous polyester resin will be explained. The first amorphous polyester resin has at least a repeating unit derived from a linear alkane dicarboxylic acid. Examples of the linear alkane dicarboxylic acid include an alkane dicarboxylic acid having 3 to 10 carbon atoms. The carbon atoms of the alkane dicarboxylic acid include carbon atoms in two carboxy groups. Examples of the linear alkane dicarboxylic acid having 3 to 10 carbon atoms include malonic acid, succinic acid, glutaric acid, adipic acid, pimelic acid, suberic acid, azelaic acid, and sebacic acid. As the linear alkane dicarboxylic acid having 3 to 10 carbon atoms, a linear alkane dicarboxylic acid having 5 to 7 carbon atoms is preferable, and adipic acid is more preferable.

Preferably, the first amorphous polyester resin has a repeating unit derived from a linear alkane dicarboxylic acid having 3 to 10 carbon atoms as the repeating unit derived from the linear alkane dicarboxylic acid (preferably a repeating unit derived from an alkane dicarboxylic acid having 5 to 7 carbon atoms, more preferably a repeating unit derived from adipic acid), a repeating unit derived from terephthalic acid, and a repeating unit derived from a bisphenol A alkylene oxide adduct. An average addition mole number of an alkylene oxide in the bisphenol A alkylene oxide adduct is preferably 2 to 6, more preferably 2.

The repeating unit derived from the linear alkane dicarboxylic acid having 3 to 10 carbon atoms, the repeating unit derived from terephthalic acid, and the repeating unit derived from the bisphenol A alkylene oxide adduct are preferably represented by the following general formula (A), chemical formula (B), and general formula (C) respectively.

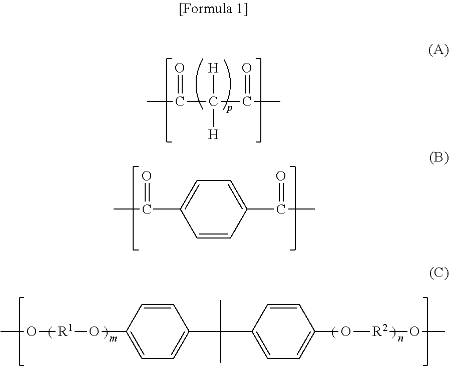

In general formula (A), p represents an integer of 1 to 8. p represents preferably an integer of 3 to 5, more preferably 4. In the general formula (C), each of R¹ and R² independently represents a linear or branched alkylene group, m represents an integer of 0 or more, n represents an integer of 0 or more, and a sum of m and n is 2 to 6. Each of R¹ and R² independently represents preferably a linear or branched alkylene group having 2 to 4 carbon atoms, more preferably an ethylene group or a propylene group. The sum of m and n is preferably 2.

For obtaining the toner particles having the predetermined features, the Tg of the first amorphous polyester resin is preferably 20° C. to 40° C., more preferably 25° C. to 35° C. For the same reason, the Tm of the first amorphous polyester resin is preferably 80° C. to less than 100° C., more preferably 85° C. to 95° C.

Next, the second amorphous polyester resin will be explained. The second amorphous polyester resin has at least a repeating unit derived from a trivalent carboxylic acid. Since the second amorphous polyester resin has the repeating unit derived from the trivalent carboxylic acid, a three-dimensional crosslinked structure can be introduced into the second amorphous polyester resin. Examples of the trivalent carboxylic acid include trimellitic acid, trimesic acid, adamantane tricarboxylic acid, and pyromellitic acid. The trivalent carboxylic acid is preferably trimellitic acid.

The second amorphous polyester resin preferably has a repeating unit derived from trimellitic acid as the repeating unit derived from the trivalent carboxylic acid, the repeating unit derived from terephthalic acid, and the repeating unit derived from the bisphenol A alkylene oxide adduct. The repeating unit derived from trimellitic acid is preferably represented by the following chemical formula (D). Each of the repeating unit derived from terephthalic acid, and the repeating unit derived from the bisphenol A alkylene oxide adduct is preferably represented by the aforementioned chemical formula (B) and general formula (C) respectively.

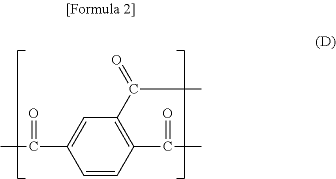

For obtaining the toner particles having predetermined features, the Tg of the second amorphous polyester resin is preferably higher than 40° C. and smaller than or equal to 60° C., more preferably 45° C. to 55° C. For the same reason, the Tm of the second amorphous polyester resin is preferably 100° C. to 120° C., more preferably 105° C. to 115° C.

Next, the third resin will be explained. The third resin contains a crystalline polyester resin and a styrene acrylic resin. The third resin may be a composite resin of the crystalline polyester resin and the styrene acrylic resin.

Examples of a polyhydric alcohol monomer suitable for synthesizing the crystalline polyester resin include an α,ω-alkanediol having 2 to 8 carbon atoms (more specifically, ethyleneglycol, 1,4-butanediol, 1,6-hexanediol, etc.). Examples of a suitable polycarboxylic acid monomer for synthesizing the crystalline polyester resin include an α,ω-alkane dicarboxylic acid having 4 to 10 carbon atoms (more specifically, succinic acid, glutaric acid, adipic acid, pimelic acid, suberic acid, azelaic acid, sebacic acid, etc.). Incidentally, the carbon atoms of the α,ω-alkane dicarboxylic acid includes carbon atoms in two carboxy groups.

An acid value of the third resin (particularly, the crystalline polyester resin constituting the third resin) is preferably 5 to 50 mgKOH/g, more preferably 10 to 40 mgKOH/g, even more preferably 20 to 30 mgKOH/g. When the acid value of the third resin is within this range, in a case that the shell layer contains an oxazoline group described later, the oxazoline group reacts with the carboxy group of the third resin and is then ring-opened, so that an amide bond and an ester bond are easily formed. Since such bonds are formed, the bond between the core and the shell layer is strengthened, the shell layer formed along the unevenness of the core and having the predetermined features and thus the toner particles having the predetermined features can be obtained.

Examples of the styrene-based monomer for synthesizing the styrene acrylic resin include styrene, o-methylstyrene, m-methylstyrene, p-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene.

Examples of the acrylic acid-based monomer for synthesizing the styrene acrylic resin include a (meth)acrylic acid, an alkyl (meth)acrylate (more specifically, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-octyl (meth)acrylate, 2-ethylhexyl (meth)acrylate, stearyl (meth)acrylate, etc.), a lauryl (meth)acrylate, and a phenyl (meth)acrylate.

Preferably, the third resin has a repeating unit derived from ethylene glycol, a repeating unit derived from an α,ω-alkane dicarboxylic acid having 4 to 10 carbon atoms (preferably a repeating unit derived from sebacic acid), a repeating unit derived from styrene, and a repeating unit derived from alkyl (meth)acrylate (preferably a repeating unit derived from alkyl methacrylate).

One resin chain may contain a repeating unit derived from ethylene glycol and a repeating unit derived from the α,ω-alkane dicarboxylic acid having 4 to 10 carbon atoms, and another resin chain may contain a repeating unit derived from styrene, and a repeating unit derived from alkyl (meth)acrylate. In addition, one resin chain may contain the repeating unit derived from ethylene glycol, the repeating unit derived from the α,ω-alkane dicarboxylic acid having 4 to 10 carbon atoms, the repeating unit derived from styrene, and the repeating unit derived from alkyl (meth)acrylate.

Preferably, the repeating unit derived from ethylene glycol, the repeating unit derived from the α,ω-alkane dicarboxylic acid having 4 to 10 carbon atoms, the repeating unit derived from styrene, and the repeating unit derived from alkyl (meth)acrylate are represented by the following chemical formula (E), general formula (F), chemical formula (G), and general formula (H) respectively.

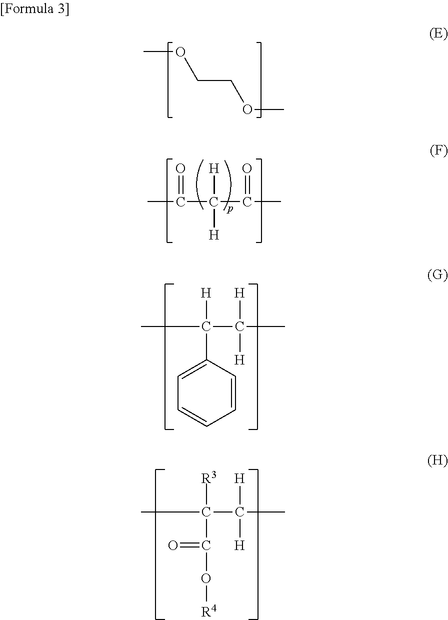

In general formula (F), p represents an integer of 2 to 8. q represents an integer of preferably 5 to 8, more preferably 8. In general formula (H), R³ represents hydrogen atom or a methyl group. Preferably, R³ represents a methyl group. R⁴ represents an alkyl group having 1 to 6 carbon atoms. R⁴ represents preferably an alkyl group having 3 to 5 carbon atoms, more preferably an alkyl group having 4 carbon atoms.

A content of the second amorphous polyester resin is preferably 80 to 120 parts by mass, more preferably 90 to 110 parts by mass, even more preferably 100 parts by mass, based on 100 parts by mass of the first amorphous polyester resin. A content of the third resin is preferably 25 to 55 parts by mass, more preferably 35 to 45 parts by mass, even more preferably 37 parts by mass, based on 100 parts by mass of the first amorphous polyester resin.

(Releasing Agent)

The releasing agent is used e.g. for obtaining a toner excellent in hot offset resistance. For obtaining a toner excellent in hot offset resistance, an amount of the releasing agent is preferably 1 to 20 parts by mass based on 100 parts by mass of the binder resin.

Examples of the releasing agent include an aliphatic hydrocarbon-based wax, an oxide of an aliphatic hydrocarbon-based wax, a plant-derived wax, an animal-derived wax, a mineral-derived wax, an ester wax containing a fatty acid ester as a main ingredient, and a wax obtained by deoxidizing a part or the whole of a fatty acid ester. Examples of the aliphatic hydrocarbon-based wax include a polyethylene wax (e.g. low molecular weight polyethylene), a polypropylene wax (e.g. low molecular weight polypropylene), a polyolefin copolymer, a polyolefin wax, a microcrystalline wax, a paraffin wax, and Fischer Tropsch wax. Examples of the oxide of the aliphatic hydrocarbon-based wax include a polyethylene oxide wax and a block copolymer of a polyethylene oxide wax. Examples of the plant-derived wax include candelilla wax, carnauba wax, Japanese wax, jojoba wax, and rice bran wax. Example of the animal-derived wax include beeswax, lanoline, and spermaceti. Examples of the mineral-derived wax include ozokerite, ceresin, and petrolatum. Examples of the ester wax containing a fatty acid ester as a main ingredient include montanic acid ester wax and castor wax. Examples of the wax obtained by deoxidizing a part or the whole of a fatty acid ester include a deoxidized carnauba wax.

(Colorant)

As the colorant, a known pigment or dye can be used depending on a color of the toner. For forming a high-quality image using the toner, an amount of the colorant is preferably 1 to 20 parts by mass based on 100 parts by mass of the binder resin.

The core may contain a black colorant. Examples of the black colorant include carbon black. In addition, the black colorant may be a colorant toned into black using a yellow colorant, a magenta colorant, and a cyan colorant.

The core may contain a coloring agent. Examples of the coloring agent include a yellow colorant, a magenta colorant, and a cyan colorant.

As the yellow colorant, for example, one or more compounds selected from a group consisting of a condensed azo compound, an isoindolinone compound, an anthraquinone compound, an azo metal complex, a methine compound, and an arylamide compound can be used. Examples of the yellow colorant include C.I. Pigment Yellow (3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191 and 194), Naphthol Yellow S, Hansa Yellow G, and C.I. Vat Yellow.

As the magenta colorant, for example, one or more compounds selected from a group consisting of a condensed azo compound, a diketopyrrolopyrrole compound, an anthraquinone compound, a quinacridone compound, a basic dye lake compound, a naphthol compound, a benzimidazolone compound, a thioindigo compound, and a perylene compound can be used. Examples of the magenta colorant include C.I. Pigment Red (2, 3, 5, 6, 7, 19, 23, 48:2, 48:3, 48:4, 57:1, 81:1, 122, 144, 146, 150, 166, 169, 177, 184, 185, 202, 206, 220, 221 and 254).

As the cyan colorant, for example, one or more compounds selected from a group consisting of a copper phthalocyanine compound, an anthraquinone compound, and a basic dye lake compound can be used. Examples of the cyan colorant include C.I. Pigment Blue (1, 7, 15, 15:1, 15:2, 15:3, 15:4, 60, 62, and 66), Phthalocyanine Blue, C.I. Vat Blue, and C.I. Acid blue.

Incidentally, the core may contain a charge control agent and an additive, as needed.

<Shell Layer>

The shell layer is substantially composed of a resin. As the resin constituting the shell layer, for example, one or more resins selected from a group consisting of a known thermosetting resin and a known thermoplastic resin can be used.

Examples of the thermosetting resin include a melamine resin, a urea resin, a glyoxal resin, and a guanamine resin.

Examples of the thermoplastic resin include a styrene resin, an acrylic ester resin, an olefin resin (more specifically, polyethylene resin, polypropylene resin, etc.), a vinyl resin (more specifically, vinyl chloride resin, polyvinyl alcohol, vinyl ether resin, N-vinyl resin, etc.), a polyester resin, a polyamide resin, and a urethane resin. In addition, a copolymer of each of these resins, i.e. a copolymer obtained by introducing any repeating unit into the aforementioned resins (more specifically, styrene acrylic resin, styrene-butadiene resin, etc.) can also be used as the resin constituting the shell layer.

When the core contains a polyester resin as the binder resin, the shell layer is preferably composed of a polymer (resin) of a monomer containing at least a compound represented by the following general formula (1) (hereinafter, referred to as compound (1) in some cases) to obtain a shell layer formed along unevenness of the core and having the predetermined features.

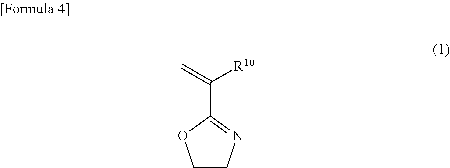

In general formula (1), R¹⁰ represents an alkyl group having 1 to 6 carbon atoms that may be substituted with a phenyl group, or hydrogen atom. R¹⁰ represents preferably hydrogen atom, a methyl group, an ethyl group, or an isopropyl group, more preferably hydrogen atom.

The polymer of the monomer containing at least the compound (1) may be a polymer of the compound (1) and a vinyl compound other than the compound (1) (hereinafter, referred to as another vinyl compound in some cases). Incidentally, the vinyl compound has a vinyl group (CH₂═CH—) or a group in which hydrogen in the vinyl group is substituted. Examples of the vinyl compound include ethylene, propylene, butadiene, vinyl chloride, (meth)acrylic acid, methyl (meth)acrylate, (meth)acrylonitrile, and styrene. The vinyl compound is addition-polymerized by a carbon-carbon double bond (C═C) contained in the vinyl group or the like to become a polymer (resin).

Another vinyl compound is preferably one or more selected from a group consisting of a (meth)acrylic acid alkyl ester (more specifically, acrylic acid alkyl ester and methacrylic acid alkyl ester), and a styrene-based monomer (more specifically, styrene).

When using a (meth)acrylic acid alkyl ester as another vinyl compound, the (meth)acrylic acid alkyl ester is preferably one or more selected from a group consisting of a methyl (meth)acrylate, an ethyl (meth)acrylate, a n-propyl (meth)acrylate, an isopropyl (meth)acrylate, a butyl (meth)acrylate (more specifically, n-butyl (meth)acrylate, isobutyl (meth)acrylate, etc.), and a 2-ethylhexyl (meth)acrylate.

The compound (1) forms a repeating unit represented by the following formula (1-1) (hereinafter, referred to as a repeating unit (1-1)) by addition polymerization. In the following formula (1-1), R¹⁰ is synonymous with R¹⁰ in formula (1).

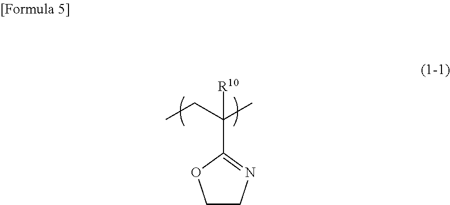

The repeating unit (1-1) has a ring-unopened oxazoline group. Once the repeating unit (1-1) reacts with the carboxy group of the polyester resin in the core, the oxazoline group is ring-opened to form an amide bond and an ester bond as illustrated in the following general formula (1-2). Since such bonds are formed, the bond between the core and the shell layer is strengthened, the shell layer formed along the unevenness of the core and having the predetermined features and thus the toner particles having the predetermined features can be obtained. Incidentally, in the following general formula (1-2), R¹⁰ is synonymous with R¹⁰ in general formula (1). Additionally, in the following general formula (1-2), a symbol “*” represents an atomic bonding that bonds to an atom in the core.

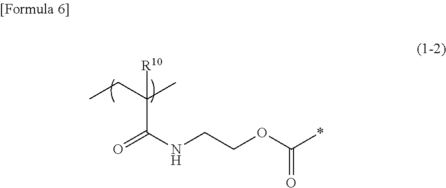

For obtaining the shell layer formed along the unevenness of the core and having the predetermined features, preferably the shell layer contains a vinyl resin having a repeating unit (1-1) and a repeating unit represented by general formula (1-2) (hereinafter, referred to as repeating unit (1-2) in some cases). For the same reason, more preferably, the shell layer contains a vinyl resin having the repeating unit (1-1), the repeating unit (1-2), and a repeating unit derived from a (meth)acrylic acid alkyl ester.

As a shell material (material for forming the shell layer), for example, an oxazoline group-containing polymer aqueous solution (“Epocros (registered trademark) WS series” manufactured by NIPPON SHOKUBAI CO., LTD.) can be used. Of this series, “Epocros (registered trademark) WS-300” contains a copolymer of 2-vinyl-2-oxazoline (a type of compound (1)) and methyl methacrylate (mass ratio of the monomers constituting the copolymer:methyl methacrylate/2-vinyl-2-oxazoline=1/9). In addition, “Epocros (registered trademark) WS-700” contains a copolymer of 2-vinyl-2-oxazoline, methyl methacrylate, and butyl acrylate (mass ratio of the monomers constituting the copolymer:methyl methacrylate/2-vinyl-2-oxazoline/butyl acrylate=4/5/1).

<External Additive>

When the toner particles have an external additive, an amount of the external additive is preferably 0.1 to 10 parts by mass based on 100 parts by mass of the toner mother particles. The external additive in the above amount makes it possible to obtain a toner excellent in fluidity and handleability can be obtained. The external additive particles are preferably inorganic particles, more preferably silica particles, and particles of metal oxides (more specifically, alumina, titanium oxide, magnesium oxide, zinc oxide, strontium titanate, barium titanate, etc.). The external additive particles may be surface-treated. For example, when silica particles are used as the external additive particles, hydrophobicity and/or positive chargeability may be imparted to the surfaces of the silica particles by a surface treatment agent.

### SECOND EMBODIMENT: TONER MANUFACTURING METHOD

The second embodiment of the present disclosure relates to a toner manufacturing method. The toner manufactured by the manufacture method according to the second embodiment is the toner according to the first embodiment. The toner manufacturing method according to the second embodiment is a method for manufacturing the toner containing toner particles. The method for manufacturing the toner according to the second embodiment includes e.g. a core forming process and a temperature raising process.

<Core Forming Step>

In the core forming step, the core is formed by e.g. a pulverization method or an agglutination method. Hereinafter, the core forming step will be explained by taking the pulverization method as an example.

The binder resin and other internal additives added as needed (e.g. a colorant and a releasing agent) are mixed to obtain a mixture. The mixture is kneaded while being melted using a melt kneader (e.g. a single-screw or twin-screw extruder) to obtain a kneaded product. The kneaded product is pulverized to obtain a core.

<Temperature Raising Process>

In the temperature raising process, while stirring the core in a liquid, the liquid is raised from the first temperature to the second temperature to obtain toner particles. The liquid contains a thickener and an aqueous medium. The thickener has a viscosity of 400 to 10000 mPa·sec. A content of the thickener is 1.0 to 10.0 parts by mass based on 1000.0 parts by mass of the aqueous medium. The second temperature is 50° C. to 60° C.

Since the liquid contains the thickener, as described in the first embodiment, the surface of the core is rubbed by the high viscosity liquid, and the minute convex portions are leveled to obtain toner particles having the predetermined features. Examples of the thickener include carboxymethyl cellulose and a salt thereof, pectin, gelatin, xanthan gum, and carrageenan. For obtaining the cores having the predetermined features, preferably, the thickener is carboxymethyl cellulose or a salt thereof. The salt is preferably a sodium salt, a potassium salt, or a calcium salt, more preferably a sodium salt.

For rubbing the surface of the core by the high viscosity liquid to obtain the toner particles having the predetermined features, the viscosity of the thickener is 400 to 10000 mPa·sec. The viscosity of the thickener is preferably 500 to 6000 mPa·sec. The viscosity of the thickener is measured by e.g. a rotation method. Specifically, under an environment at 25° C., in a condition that a cylinder of a rotary viscometer (Type B viscometer) is rotated 60 times, a 1% by mass thickener aqueous solution is measured to determine a viscosity of the thickener.

For rubbing the surface of the core by the high viscosity liquid to obtain the toner particles having the predetermined features, a content of the thickener is preferably 1.0 to 10.0 parts by mass, more preferably 2.0 to 10.0 parts by mass, even more preferably 3.0 to 8.0 parts by mass based on 1000.0 parts by mass of the aqueous medium.

The aqueous medium contained in the liquid is water or a dispersion medium containing water as a main ingredient. The aqueous medium may further contain a polar solvent (more specifically, methanol, ethanol, etc.) in addition to water. A content of water in the aqueous medium is preferably 90% by mass or more, more preferably 95% by mass or more, and particularly preferably 100% by mass.

Preferably, the first temperature is 25° C. to 35° C. The second temperature is 50° C. to 60° C. Since the second temperature is the above temperature, the raising of temperature is terminated after the minute convex portions that affect the surface roughness are leveled and before the large convex portions that affect the circularity are leveled. As a result, toner particles having the predetermined features can be obtained. A rate of raising the temperature of the liquid is preferably 0.1 to 1.0° C./min, more preferably 0.4 to 0.6° C./min Immediately after the liquid is raised to the second temperature, the liquid may be cooled to room temperature (preferably 10° C. to 30° C., more preferably 25° C.). In addition, after the liquid is raised to the second temperature, the liquid may be kept at the second temperature. When the liquid is kept at the second temperature, a duration for keeping the temperature (keeping time) is e.g. 15 to 45 minutes. After the liquid is kept at the second temperature, the liquid is cooled to room temperature (preferably 10° C. to 30° C., more preferably 25° C.).

For softening the binder resin to be contained in the core to enhance the leveling of the minute convex portions of the core and for adjusting the average surface roughness of the core (and thus the average surface roughness Ra of the toner particles), the pH of the liquid is preferably an alkaline pH, more preferably 8.0 or higher, even more preferably 11.0 or higher. Although the upper limit of the pH of the liquid is not particularly limited, The pH of the liquid is preferably 14.0 or lower, more preferably 13.0 or lower, even more preferably 12.0 or lower.

(Temperature Raising Process in a Case of Manufacturing Unencapsulated Toner Particle)

A temperature raising process in a case of manufacturing a toner particle having a core and no shell layer (unencapsulated toner particle) will be explained. In the temperature raising process, a core having the predetermined features is obtained. The core having the predetermined features is equivalent to the toner particle having the predetermined features.

(Temperature Raising Process in a Case of Manufacturing Encapsulated Toner Particle)

A temperature raising process in a case of manufacturing a toner particle having a core and a shell layer covering the core (encapsulated toner particle) will be explained. In the temperature raising process, the shell layer is also formed. Thereby, in the temperature raising process, it is possible to simultaneously conduct all of a process of regulating the surface of the core so as to have the predetermined features, a process of forming the shell layer on the surface of the core, and a process of regulating the surface of the shell layer so as to have the predetermined features, resulting in the toner particle having the predetermined features.

Specifically, in addition to the thickener and the aqueous medium, shell materials are further added to the liquid. In the temperature raising process, the shell materials polymerize with each other by raising the temperature of the liquid, to form the shell layer.

When the toner particle is an encapsulated toner particle, the core having the predetermined features is covered with a very thin shell layer, and therefore there is a tendency that the unevenness on the surface of the core directly appears as the unevenness on the surface of the shell layer (equivalent to the unevenness on the surface of the toner particle). Thus, since the core having the predetermined features is coated with the shell layer, the shell layer having the predetermined features and thus the toner particle having the predetermined features can be obtained. For obtaining the shell layer formed along the unevenness of the core and having predetermined features, a thickness of the shell layer is preferably smaller than the value of the average surface roughness of the toner particle. For the same reason, the thickness of the shell layer is preferably 5 nm to less than 30 nm. The thickness of the shell layer is measured by observing a cross-sectional slice of the toner using a transmission electron microscope (TEM, e.g. “H-7100FA” manufactured by Hitachi High-Tech Corporation) to obtain a TEM image, and analyzing the TEM image using an image analysis software (“WinROOF” manufactured by MITANI CORPORATION).

<External Additive Applying Step>

When the toner particle includes an external additive, an external additive applying step is conducted. In the external additive applying step, an external additive is attached to the surface of the toner mother particle equivalent to the toner particle obtained in the temperature raising process. Examples of a method of attaching the external additive to the surface of the toner mother particle include a method of attaching the external additive particles to the surfaces of the toner mother particles by mixing the toner mother particles and the external additive particles using a mixer. As described above, the toner manufacturing method according to the second embodiment has been explained.

### EXAMPLES

Examples of the present disclosure will be explained below. Note that, in evaluation in which an error occurs, a considerable number of measured values for sufficiently decreasing the error are obtained, and an arithmetic average value of the obtained measured values was defined as the evaluation value.

Hereinafter, a method for synthesizing the binder resin for use in manufacturing the toner will be explained. In addition, a preparation method, a measurement method, an evaluation method, and evaluation results of toners TA-1 to TA-7 according to Examples and toners TB-1 to TB-7 according to Comparative Example will be explained. Configurations of the toners TA-1 to TA-7 are presented in the following Table 1. Configurations of the toners TB-1 to TB-7 are presented in the following Table 2.

[Synthesis of Binder Resin]

### <Synthesis of Composite Resin R>

A 10 L-capacity four-neck flask equipped with a thermometer, a nitrogen introduction tube, a stirrer (stainless steel impeller), and a flow-down type capacitor (heat exchanger) was set onto a mantle heater. The flask was charged with 69 g of ethylene glycol, 214 g of sebacic acid, and 54 g of tin(II) 2-ethylhexanoate. An inside of the flask was converted into nitrogen atmosphere, then the flask was heated for 2 hours until a temperature of the flask content reached 235° C. Subsequently, under a condition of nitrogen atmosphere and 235° C., the flask content was condensation-polymerized while stirring until a reaction rate reached 95% by mass. The reaction rate was calculated in accordance with an equation “reaction rate=100×actual amount of reaction-produced water/theoretical amount of produced water”.

Subsequently, the flask was cooled until the temperature of the flask content reached 160° C. A mixture of 156 g of styrene, 195 g of n-butyl methacrylate and 0.5 g of di-tert-butyl peroxide was dripped into the flask using a dropping funnel for 1 hour. Subsequently, the flask content was stirred for another 30 minutes while keeping the temperature of the flask content at 160° C. Subsequently, the flask content was reacted under a condition of reduced pressure atmosphere (pressure: 8 kPa) and 200° C. for one hour, and then the flask was cooled until the temperature of the flask content reached 180° C. The pressure inside the flask was returned to normal pressure, and 1.0 g of 4-tert-butylcatechol as a radical polymerization inhibitor was put into the flask. Subsequently, the flask content was heated under a reduced pressure atmosphere (pressure: 8 kPa) for 2 hours until the temperature of the flask content reached 210° C. Subsequently, the flask content was reacted under a reduced pressure atmosphere (pressure: 8 kPa) for 1 hour while keeping the temperature of the flask content at 210° C. Subsequently, the pressure inside the flask was reduced, and the flask content was reacted under a condition of reduced pressure atmosphere (pressure: 40 kPa) and 210° C. for 2 hours. As a result, a composite resin R that is a composite resin of a crystalline polyester resin and a styrene-butyl methacrylate copolymer was obtained. The obtained composite resin R had a crystallinity index (i.e. Tm/Mp) of 1.10. The composite resin R had an acid value of 25 mgKOH/g.

<Synthesis of Amorphous Polyester Resin APES-1>

A 10 L-capacity four-neck flask equipped with a thermometer, a nitrogen introduction tube, a stirrer (stainless steel impeller), and a flow-down type capacitor (heat exchanger) was prepared. The flask was charged with 100 g of bisphenol A ethylene oxide adduct (average addition molar number of ethylene oxide: 2 mol), 100 g of bisphenol A propylene oxide adduct (average addition molar number of propylene oxide: 2 mol), 50 g of terephthalic acid, 30 g of adipic acid, and 54 g of tin(II) 2-ethylhexanoate. Subsequently, the inside of the flask was converted into nitrogen atmosphere, then the flask was heated while stirring the flask content until a temperature of the flask content reached 235° C. Under a condition of nitrogen atmosphere and 235° C., the flask content was condensation-polymerized while stirring the flask content until resin raw materials (bisphenol A ethylene oxide adduct, bisphenol A propylene oxide adduct, terephthalic acid, and adipic acid) were all dissolved. Subsequently, under a condition of reduced pressure atmosphere (pressure: 8 kPa) and 235° C., the flask content was reacted until a Tm of the reaction product (resin) reached 90° C., to obtain an amorphous polyester resin APES-1. The amorphous polyester resin APES-1 had a Tg of 30° C. and a Tm of 90° C. The amorphous polyester resin APES-1 did not show any clear endothermic peak in an endothermic curve measured using a differential scanning calorimeter, and was therefore judged to be amorphous.

<Synthesis of Amorphous Polyester Resin APES-2>

A 10 L-capacity four-neck flask equipped with a thermometer, a nitrogen introduction tube, a stirrer (stainless steel impeller), and a flow-down type capacitor (heat exchanger) was prepared. The flask was charged with 100 g of bisphenol A ethylene oxide adduct (average addition molar number of ethylene oxide: 2 mol), 100 g of bisphenol A propylene oxide adduct (average addition molar number of propylene oxide: 2 mol), 60 g of terephthalic acid, and 54 g of tin(II) 2-ethylhexanoate. Subsequently, the inside of the flask was converted into nitrogen atmosphere, then the flask was heated while stirring the flask content until a temperature of the flask content reached 235° C. Under a condition of nitrogen atmosphere and 235° C., the flask content was condensation-polymerized while stirring the flask content until resin raw materials (bisphenol A ethylene oxide adduct, bisphenol A propylene oxide adduct, and terephthalic acid) were all dissolved. Subsequently, 10 g of trimellitic anhydride was added into the flask. Subsequently, under a condition of reduced pressure atmosphere (pressure: 8.0 kPa) and 235° C., the flask content was reacted until a Tm of the reaction product (resin) reached 110° C., to obtain an amorphous polyester resin APES-2. The amorphous polyester resin APES-2 had a Tg of 50° C. and a Tm of 110° C. The amorphous polyester resin APES-2 had a crosslinked structure derived from the trimellitic acid. The amorphous polyester resin APES-2 did not show any clear endothermic peak in an endothermic curve measured using a differential scanning calorimeter, and was therefore judged to be amorphous.

[Preparation of Toner]

### <Preparation of Toner TA-1>

### (Formation of Core)

Using an FM mixer (“FM-20B” manufactured by NIPPON COKE & ENGINEERING CO., LTD.), 35 parts by mass of amorphous polyester resin APES-1, 35 parts by mass of amorphous polyester resin APES-2, 12 parts by mass of composite resin R, 9 parts by mass of releasing agent (ester wax, “Nissan Elector (registered trademark) WEP-8” manufactured by NOF CORPORATION), and 9 parts by mass of colorant (carbon black, “MA100” manufactured by Mitsubishi Chemical Corporation) were mixed to obtain a mixture.

Using a twin-screw extruder (“PCM-30” manufactured by Ikegai Corp.), the obtained mixture was kneaded while melting under a condition of a material feeding rate of 100 g/min, a shaft rotation speed of 150 rpm, and a preset temperature (cylinder temperature) of 100° C., to obtain a kneaded product. The kneaded product was cooled. The cooled kneaded product was coarsely pulverized using a pulverizer (“Rotoplex (registered trademark)” manufactured by Hosokawa Micron Corporation) under a condition of a preset particle diameter of 2 mm, to obtain a coarsely pulverized product. The coarsely pulverized product was finely pulverized using a pulverizer (“Turbo Mill Type RS” manufactured by FREUND-TURBO CORPORATION) to obtain a finely pulverized product. The finely pulverized product was classified using a classifier (air classifier utilizing Coanda effect, “Elbow Jet Type EJ-LABO” manufactured by Nittetsu Mining Co., Ltd.) to obtain a core. The obtained core had a D₅₀ of 6.7 μm.

(Formation of Shell Layer)

A 1 L-capacity three-neck flask equipped with a thermometer and an impeller was set onto a water bath. The flask was charged with 100 mL of ion-exchanged water. The water bath was used to keep the flask content at 30° C. 1 g of thickener a (“CMC Daicel 2200” manufactured by DAICEL FINE CHEM Ltd.), and 10 g of shell material (oxazoline group-containing polymer aqueous solution, “Epocros (registered trademark) WS-700” manufactured by NIPPON SHOKUBAI CO., LTD, solid concentration: 25% by mass) were added into the flask. The flask content was stirred and 100 g of core was added into the flask. The flask content was stirred at a rotation speed of 200 rpm for 1 hour. 100 mL of ion-exchanged water was added into the flask. Then, 4 mL of 1% by mass ammonia aqueous solution was added into the flask to adjust a pH of the flask content (liquid) from 4.2 to 11.4. The temperature of the liquid was raised while stirring the flask content (liquid) at a rotation speed of 150 rpm. Specifically, the liquid was heated from an initial temperature (first temperature) of 30° C. to a final reaching temperature (second temperature) of 50° C. at a temperature raising rate of 0.5° C./min (corresponding to the temperature raising process). Subsequently, after the temperature of the liquid reached the final reaching temperature of 50° C., the liquid was kept at 50° C. for 30 minutes (keeping time: 30 minutes). Then, the liquid was cooled until the temperature of the liquid reached 25° C., to obtain a toner mother particle dispersion.

(Washing Step)

The obtained toner mother particle dispersion was filtered using Buchner funnel to obtain wet cake-like toner mother particles. Subsequently, the wet cake-like toner mother particles were redispersed in ion-exchanged water and then filtered using Buchner funnel. Furthermore, the toner mother particles were washed by repeating redispersion and filtration 5 times.

(Drying Step)

The washed toner mother particles were dried using a continuous surface reforming device (“COATMIZER (registered trademark)” manufactured by Freund Corporation) under a condition of a hot air temperature of 45° C. and a blower flow rate of 2 m³/min As a result, a powder of the dried toner mother particles was obtained.

(External Additive Applying Step)

Using an FM mixer (“FM-10B” manufactured by NIPPON COKE & ENGINEERING CO., LTD., capacity: 10 L), 100 parts by mass of toner mother particles and 3 parts by mass of positive charge type silica particles (“AEROSIL (registered trademark) REA90” manufactured by NIPPON AEROSIL CO., LTD., contents: dry silica particles imparted with positive chargeability by surface treatment, number average primary particle diameter: 20 nm) were mixed for 5 minutes. Thereby, an external additive (silica particles) adhered to the surfaces of the toner mother particles. The toner mother particles to which the external additive adhered were sieved using a sieve with 200 mesh (opening: 75 μm). As a result, a toner TA-1 containing toner particles was obtained.

<Preparation of Toners TA-2 to TA-6 and TB-1 to TB-7>

Each of toners TA-2 to TA-6 and TB-1 to TB-7 was prepared using the same method as for the preparation of the toner TA-1 except that the shell layer was formed under manufacturing conditions presented in Tables 1 and 2 (specifically, type and amount of thickener, temperature raising rate, initial temperature, final reaching temperature, and keeping time).

<Preparation of Toner TA-7>

A toner TA-7 was prepared using the same method as for the preparation of toner TA-1 except that the following operations were performed instead of the aforementioned operation (formation of the shell layer). Specifically, a 1 L-capacity three-neck flask equipped with a thermometer and an impeller was set onto a water bath. The flask was charged with 100 mL of ion-exchanged water. The water bath was used to keep the flask content at 30° C. 1 g of thickener a (“CMC Daicel 2200” manufactured by DAICEL FINE CHEM Ltd.) was added into the flask. Incidentally, no shell material was added. The flask content was stirred and 100 g of core was added into the flask. The flask content was stirred at a rotation speed of 200 rpm for 1 hour. 100 mL of ion-exchanged water was added into the flask. Then, 4 mL of 1% by mass ammonia aqueous solution was added into the flask to adjust a pH of the flask content (liquid) from 4.2 to 11.4. The temperature of the liquid was raised while stirring the flask content (liquid) at a rotation speed of 150 rpm. Specifically, the liquid was raised from an initial temperature (first temperature) to a final reaching temperature (second temperature) at a heating rate of 0.5° C./min (corresponding to the temperature raising process). Subsequently, after the temperature of the liquid reached the final reaching temperature, the liquid was kept at the final reaching temperature for a predetermined keeping time. Incidentally, each of the initial temperature, the final reaching temperature, and the keeping time was as presented in the toner “TA-7” column in Table 1. Then, the liquid was cooled until the temperature of the liquid reached 25° C., to obtain a toner mother particle dispersion. Subsequently, the aforementioned washing step, drying step, and external additive applying step were conducted.

[Measurement Method]

For each of the prepared toners, an average circularity C of the toner particles, an average surface roughness Ra of the toner particles, and a surface roughness standard deviation σRa of the toner particles were measured by the following methods.

<Measurement Method of Average Circularity>

### (Preparation of Measurement Sample)

A measurement sample for use in measuring the average circularity was prepared using the following method. First, a surfactant (“Contaminon (registered trademark) N” manufactured by Wako Pure Chemical Industries, Ltd.) was diluted by 3 times by mass with ion-exchanged water to obtain a diluent A. Contaminon (registered trademark) N was a 10% by mass neutral detergent aqueous solution for washing precision measuring instruments. This neutral detergent for cleaning precision measuring instruments was at pH 7, and composed of a nonionic surfactant, an anionic surfactant, and an organic builder.

Next, a glass container was charged with 20 mL of ion-exchanged water from which impure solid matters had been removed, 0.2 mL of diluent A, and 0.02 g of toner. While cooling the container content so as to be at 10° C. to 40° C., the container content was dispersed using an ultrasonic disperser for 2 minutes to obtain a dispersion B. An ultrasonic washer (“VS-150” manufactured by VELVO-CLEAR Co., Ltd., oscillatory frequency: 50 kHz, high frequency output: 150 W, desktop type) was used as the ultrasonic disperser for the dispersion treatment. The obtained dispersion B was used as a measurement sample.

(Measurement of Average Circularity)

The average circularity of the toner was measured using a flow-type particle image analyzer (“FPIA (registered trademark)-3000” manufactured by Sysmex Corporation) equipped with a standard objective lens (10 magnifications). As a sheath liquid, “Particle Sheath PSE-900A” manufactured by Sysmex Corporation was used. The prepared measurement sample was introduced into the flow-type particle image analyzer, and circularities of 30,000 toner particles contained in the measurement sample were measured. In the measurement condition, the mode was an HPF measurement mode and a total count mode, a binarization threshold value during the particle analysis was 85%, and an analysis particle diameter was 1.985 μm to less than 39.69 μm that was a circle-equivalent diameter. The average circularity of the toner particles was determined by dividing a sum of the measured circularities of the 30,000 toner particles by the measured number (30,000) of the particles.

(Focus Adjustment)

The following focus adjustments were performed as calibration in measuring the average circularity of the toner. First, before the start of the measurement, automatic focus adjustment was performed using standard latex particles. Standard latex particles were prepared by diluting “RESEARCH AND TEST PARTICLES Latex Microsphere Suspensions 5200A” manufactured by Duke Scientific Corporation by 200 times by mass with ion-exchanged water. In addition, the focus was adjusted by the same method every 2 hours from the start of the measurement.

<Measurement of Average Surface Roughness Ra and Standard Deviation σRa>

A surface roughness of the toner particles was measured using a scanning probe microscope (SPM, “multifunctional unit AFM5200S” manufactured by Hitachi High-Tech Science Corporation) in accordance with the following measurement condition.

### (Measurement Condition)

Measurement mode: DFM (resonance mode)-shaped image

Cantilever: SI-DF3-R

Resolution (X data/Y data): 256/256

Measurement area: 1 μm-square area in the center of the surface of the toner particle, observed using the scanning probe microscope

The surface roughness of the toner particles was measured for 100 toner particles randomly selected. From the measured surface roughness of 100 toner particles, an average surface roughness Ra and a standard deviation σRa of the toner particles were calculated. In addition, from an equation “ratio σRa/Ra=surface roughness standard deviation σRa of the toner particles/average surface roughness Ra of the toner particles”, a ratio σRa/Ra was calculated.

The measured average circularity C, average surface roughness Ra, and ratio σRa/Ra of the toner particles are presented in Tables 1 and 2.

[Evaluation Method]

### <Preparation of Evaluation Developer>

As a carrier for a developer, a carrier for a color multifunction machine (“TASKalfa5550ci” manufactured by Kyocera Document Solutions Co., Ltd.) was used. The developer carrier and 10% by mass of toner based on a mass of the carrier were mixed using a ball mill for 30 minutes to obtain an evaluation developer that is a two-component developer.

<Evaluation of Transferability>

As an evaluation apparatus, the color multifunction machine (“TASKalfa5550ci” manufactured by Kyocera Document Solutions Co., Ltd.) was used. An evaluation developer was put into a black developing device of the evaluation apparatus. A replenishment toner (the same toner as the toner contained in the evaluation developer) was put into the black toner container of the evaluation apparatus. A development condition was set such that an amount of the toner adhering to a photoconductor drum included in the evaluation apparatus was 5 mg/cm² after development.

Subsequently, under an environment of 20° C. and a relative humidity of 65% RH, an image (pattern image with a printing rate of 5%) was continuously printed on 2,000 sheets of paper using the evaluation apparatus. After the printing, a mass of the toner developed on the paper (developed toner amount, unit: g), and a mass of the toner recovered in a cleaning section included in the evaluation apparatus (recovered toner amount, unit: g) were measured. A toner transfer efficiency (unit: %) was calculated from an equation “transfer efficiency=100×developed toner amount/(developed toner amount+recovered toner amount)”. From the calculated toner transfer efficiency, the toner transferability was evaluated in accordance with the following criteria.

### (Evaluation Criteria of Transferability)

Evaluation A (Excellent): The toner transfer efficiency is 95% or higher.

Evaluation B (Good): The toner transfer efficiency is 90% to lower than 95%.

Evaluation C (Poor): The toner transfer efficiency is lower than 90%.

<Evaluation of Cleanability>

In the above section <Evaluation of Transferability>, after printing on 2,000 sheets of paper and before measurement of the developed toner amount and the recovered toner amount, a blank image was printed on one sheet of paper using the evaluation apparatus. The blank image was visually confirmed to judge whether or not an image noise corresponding to toner dropping from the cleaning section occurred. If an image noise occurred, a reflection density of the blank image where a noise had occurred was measured using a fully automatic whiteness meter (“TC-6MC” manufactured by Tokyo Denshoku CO., LTD.). From an equation “fog density=reflection density of blank image-reflection density of unprinted paper”, a fog density (FD) was calculated. From the result of visual confirmation and the calculated FD, the cleanability was evaluated in accordance with the following criteria.

### (Evaluation Criteria of Cleanability)

Evaluation A (Excellent): No image noise occurred.

Evaluation B (Good): An image noise occurred, but the FD is 0.01 or lower.

Evaluation C (Poor): An image noise occurred, and the FD is higher than 0.01.

Evaluation results of the transferability and the cleanability of each toner are presented in Tables 1 and 2.

TABLE 1

| | | | Example | Example | Example | Example | Example | Example | Example |
|---|---|---|---|---|---|---|---|---|---|
| | | | 1 | 2 | 3 | 4 | 5 | 6 | 7 |
| Toner No. | | | TA-1 | TA-2 | TA-3 | TA-4 | TA-5 | TA-6 | TA-7 |
| Manufacture | Thickener | Type | a | a | a | c | d | a | a |
| condition | | Amount [g] | 1 | 0.5 | 1 | 1 | 1 | 2 | 1 |
| | | Concentration | 4.7 | 2.4 | 4.7 | 4.7 | 4.7 | 9.5 | 4.9 |
| | | [parts/1000 parts] | | | | | | | |

| | | | | | | | | |
|---|---|---|---|---|---|---|---|---|
| | Heating rate [° C./min] | 0.5 | 0.5 | 0.5 | 0.5 | 0.5 | 0.5 | 0.5 |
| | Initial temperature [° C.] | 30 | 30 | 30 | 30 | 30 | 30 | 30 |
| | Final reaching temperature [° C.] | 50 | 50 | 60 | 50 | 50 | 50 | 50 |
| | Keeping time [min] | 30 | 30 | 0 | 30 | 45 | 15 | 30 |
| Toner | Shell layer | Any | Any | Any | Any | Any | Any | None |
| configuration | Average circularity C | 0.948 | 0.946 | 0.946 | 0.947 | 0.946 | 0.948 | 0.949 |
| | Average roughness Ra [nm] | 39 | 86 | 71 | 35 | 92 | 34 | 31 |
| | σRa/Ra | 0.2 | 0.2 | 0.3 | 0.2 | 0.1 | 0.2 | 0.3 |
| Evaluation | Transferability | A | B | B | A | B | A | B |
| | Cleanability | A | A | B | B | A | B | B |

TABLE 2

| | | | Comparative | Comparative | Comparative | Comparative | Comparative | Comparative | Comparative |
|---|---|---|---|---|---|---|---|---|---|
| | | | Example 1 | Example 2 | Example 3 | Example 4 | Example 5 | Example 6 | Example 7 |
| Toner No. | | | TB-1 | TB-2 | TB-3 | TB-4 | TB-5 | TB-6 | TB-7 |
| Manufacture | Thickener | Type | — | a | a | a | b | a | e |
| condition | | Amount [g] | — | 1 | 1 | 1 | 1 | 0.1 | 1 |
| | | Concentration | — | 4.7 | 4.7 | 4.7 | 4.7 | 0.5 | 4.7 |
| | | [parts/1000 parts] | | | | | | | |

| | | | | | | | | |
|---|---|---|---|---|---|---|---|---|
| | Heating rate [° C./min] | 0.5 | 0.5 | 0.5 | 0.5 | 0.5 | 0.5 | 0.5 |
| | Initial temperature [° C.] | 30 | 30 | 30 | 30 | 30 | 30 | 30 |
| | Final reaching temperature [° C.] | 50 | 70 | 40 | 40 | 50 | 50 | 50 |
| | Keeping time [min] | 30 | 0 | 0 | 30 | 30 | 30 | 30 |
| Toner | Shell layer | Any | Any | Any | Any | Any | Any | Any |
| configuration | Average circularity C | 0.948 | 0.987 | 0.943 | 0.943 | 0.947 | 0.947 | 0.948 |
| | Average roughness Ra [nm] | 127 | 12 | 130 | 85 | 119 | 122 | 26 |
| | σRa/Ra | 0.2 | 0.1 | 0.6 | 0.4 | 0.2 | 0.2 | 0.2 |
| Evaluation | Transferability | C | A | C | C | C | C | A |
| | Cleanability | A | C | B | A | A | B | C |

The meaning of each term in Tables 1 and 2 will be explained. The “Any” in the column “shell layer” indicates that the toner particle includes the shell layer, i.e. the toner particle is an encapsulated toner particle. The “None” in the column “shell layer” indicates that the toner particle does not include the shell layer, i.e. the toner particle is an unencapsulated toner particle. The “average roughness Ra” indicates the average surface roughness of the toner particles. The “σRa/Ra” indicates the ratio σRa/Ra. The “-” indicates that the toner does not contain the corresponding component.

The “parts” indicates “parts by mass”. The “concentration” of the “thickener” indicates a content (unit: parts by mass) of the thickener based on 1000.0 parts by mass of the aqueous medium. The content of the thickener was calculated from an equation “(content of thickener)=1000×(mass of thickener)/(mass of aqueous medium)”. The mass of the thickener refers to the mass of the thickener contained in the liquid in the temperature raising process, and the mass of the aqueous medium refers to the mass of the aqueous medium contained in the liquid in the temperature raising process. In preparing the toners TA-1 to TA-6 and TB-2 to TB-7, the mass of the aqueous medium was 211.46 g (specifically, 100 g of ion-exchanged water, 7.5 g of water contained in the shell material (10 g, solid concentration: 25% by mass), 100 g of ion-exchanged water, and 3.96 g of water contained in an ammonia aqueous solution (4 mL, concentration: 1% by mass)). In preparing the toner TA-7, the mass of the aqueous medium was 203.96 g (specifically, 100 g of ion-exchanged water, 100 g of ion-exchanged water, and 3.96 g of water contained in an ammonia aqueous solution (4 mL, concentration: 1% by mass)). Incidentally, the mass in terms of 1 mL of water was 1 g.

The thickeners a to e presented in Tables 1 and 2 are as follows.

Thickener a: “CMC Daicel 2200” manufactured by DAICEL FINE CHEM Ltd. (component: sodium carboxymethyl cellulose, viscosity: 2250 mPa·s)

Thickener b: “CMC Daicel 1150” manufactured by DAICEL FINE CHEM Ltd. (component: sodium carboxymethyl cellulose, viscosity: 250 mPa·s)

Thickener c: “CMC Daicel 2260” manufactured by DAICEL FINE CHEM Ltd. (component: sodium carboxymethyl cellulose, viscosity: 5000 mPa·s)

Thickener d: “CMC Daicel 1170” manufactured by DAICEL FINE CHEM Ltd. (component: sodium carboxymethyl cellulose, viscosity: 650 mPa·s)

Thickener e: “CMC Daicel 2280” manufactured by DAICEL FINE CHEM Ltd. (component: sodium carboxymethyl cellulose, viscosity: 15500 mPa·s)

As illustrated in Table 1, each of the toners TA-1 to TA-7 had the following configuration. The toner particles contained in the toner had an average circularity C of 0.900 to 0.950. The toner particles had an average surface roughness of 30 to 100 nm. The toner particles had a ratio σRa/Ra of 0.3 or lower. Thus, as presented in Table 1, for the toners TA-1 to TA-7, the transferability was evaluated as A or B, and the cleanability was evaluated as A or B. The above results revealed that the toner according to the present disclosure could exhibit both good transferability and good cleanability.

In addition, as presented in Table 1, each of the toners TA-1 to TA-7 was manufactured under the following condition. A temperature raising step in which, while stirring a core in a liquid containing the thickener and the aqueous medium, the liquid was raised from a first temperature (initial temperature) to a second temperature (final reaching temperature) to obtain the toner particle, was conducted. The thickeners (specifically, thickeners a, c, and d) had a viscosity of 400 to 10000 mPa·sec. A content of the thickener was 1.0 to 10.0 parts by mass based on 1000.0 parts by mass of the aqueous medium. The final reaching temperature was 50° C. to 60° C. As described above, for the toners TA-1 to TA-7, the transferability was evaluated as A or B, and the cleanability was evaluated as A or B. The above results revealed that the toner manufactured by the manufacturing method according to the present disclosure could exhibit both good transferability and good cleanability.

The toner according to the present disclosure, and the toner manufactured by the manufacturing method according to the present disclosure can be used e.g. for forming an image in a multifunction machine or a printer.

What is claimed is:

1. A toner containing toner particles, wherein
an average circularity of the toner particles is 0.900 to 0.950,
an arithmetic average value of a surface roughness of the toner particles is 30 to 100 nm, and
a ratio of a standard deviation of the surface roughness of the toner particles to the arithmetic average value is 0.3 or lower.

2. The toner according to claim 1, wherein the arithmetic mean value of the surface roughness of the toner particles is 30 to 50 nm.

3. The toner according to claim 1, wherein
the toner particles contain a binder resin,
the binder resin contains a first amorphous polyester resin, a second amorphous polyester resin, and a third resin,
the first amorphous polyester resin has at least a repeating unit derived from a linear alkane dicarboxylic acid,
the second amorphous polyester resin has at least a repeating unit derived from a trivalent carboxylic acid, and
the third resin contains a crystalline polyester resin and a styrene acrylic resin.

4. The toner according to claim 3, wherein the first amorphous polyester resin has a repeating unit derived from adipic acid as the repeating unit derived from the linear alkane dicarboxylic acid, a repeating unit derived from terephthalic acid, and a repeating unit derived from a bisphenol A alkylene oxide adduct, and
the second amorphous polyester resin has a repeating unit derived from trimellitic acid as the repeating unit derived from the trivalent carboxylic acid, the repeating unit derived from terephthalic acid, and the repeating unit derived from the bisphenol A alkylene oxide adduct.

5. A method for manufacturing a toner containing toner particles, comprising
a temperature raising process in which, while stirring a core in a liquid containing a thickener and an aqueous medium, the liquid is raised from a first temperature to a second temperature to obtain the toner particles, wherein
a viscosity of the thickener is 400 to 10000 mPa·sec,
a content of the thickener is 1.0 to 10.0 parts by mass based on 1000.0 parts by mass of the aqueous medium,
the second temperature is 50° C. to 60° C.,
an average circularity of the toner particles is 0.900 to 0.950,
an arithmetic average value of a surface roughness of the toner particles is 30 to 100 nm, and
a ratio of a standard deviation of the surface roughness of the toner particles to the arithmetic average value is 0.3 or lower.

6. The toner manufacturing method according to claim 5, wherein the thickener is carboxymethyl cellulose or a salt thereof.
